(19) United States
(12) Patent Application Publication
(10) Pub. No.: US 2024/0385887 A1
(43) Pub. Date: Nov. 21, 2024

(54) DISTRIBUTED RESOURCE CONTROLLERS FOR CLOUD INFRASTRUCTURE

(71) Applicant: Rubrik, Inc., Palo Alto, CA (US)

(72) Inventors: Jun Xu, Seattle, WA (US); David Anthony Terei, New York, NY (US); Vinay Patil, Santa Clara, CA (US)

(21) Appl. No.: 18/319,110

(22) Filed: May 17, 2023

(51) Int. Cl. G06F 9/50

(52) U.S. Cl. CPC G06F 9/5038; G06F 9/5072; G06F 2209/508

(57) ABSTRACT

Methods, systems, and devices for data management are described. Some systems may include a job engine associated with one or more software-as-a-service (SaaS) services. The job engine may identify computing resources distributed across one or more cloud environments. The computing resources may be of two or more different resource types. The job engine may generate multiple resource controllers associated with the computing resources. The resource controllers may be of two or more different controller types and may each be mapped to a respective computing resource based on a resource type of the computing resource and a controller type of the resource controller. A resource controller may be operable to monitor, based on a set of tasks generated by the job engine, one or more parameters associated with a computing resource and modify, based on the set of tasks, the one or more parameters associated with the computing resource.

### FIELD OF TECHNOLOGY

The present disclosure relates generally to data management, including techniques for distributed resource controllers for cloud infrastructure.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports distributed resource controllers for cloud infrastructure in accordance with aspects of the present disclosure.

FIG. 2 shows an example of a Software-as-a-Service (SaaS) system that supports distributed resource controllers for cloud infrastructure in accordance with aspects of the present disclosure.

FIG. 3 shows an example of a process flow that supports distributed resource controllers for cloud infrastructure in accordance with aspects of the present disclosure.

FIGS. 4 and 5 show block diagrams of devices that support distributed resource controllers for cloud infrastructure in accordance with aspects of the present disclosure.

FIG. 6 shows a block diagram of a job engine that supports distributed resource controllers for cloud infrastructure in accordance with aspects of the present disclosure.

FIG. 7 shows a diagram of a system including a device that supports distributed resource controllers for cloud infrastructure in accordance with aspects of the present disclosure.

FIGS. 8 through 10 show flowcharts illustrating methods that support distributed resource controllers for cloud infrastructure in accordance with aspects of the present disclosure.

### DETAILED DESCRIPTION

Some systems may support Software-as-a-Service (SaaS), which may refer to a software distribution model in which applications are hosted by a service provider and made available to one or more client devices over a network. A SaaS system (e.g., a data management system (DMS) or some other system that operates according to SaaS) may operate using computing resources distributed across one or more cloud environments. A computing resource as described herein may represent an example of a cloud resource, a tenant network resource, some other type of resource, or any combination thereof. The SaaS system may include multiple controllers that monitor the computing resources and update or mutate (e.g., modify or otherwise alter) the computing resources as needed. In some systems, the controllers may be local controllers that monitor resources using logic local to the controllers, where the logic may run continuously until disrupted. In such systems, if the monitoring indicates an issue with one or more computing resources, the controllers may perform updates to the computing resources or the updates may be performed manually by an engineer or operator. The local controllers may be generated when a SaaS service (e.g., a service or product provided by the SaaS system) is initiated. If such a local controller fails or is disrupted, there may not be a mechanism for restarting the controller, which may increase latency, increase processing resources, and reduce reliability.

Techniques, systems, and devices described herein define a framework that may support distributed controllers for monitoring the computing resources used to instantiate one or more SaaS services across cloud environments. A job engine (e.g., a Korg engine or some other type of job engine) may be introduced that manages the distributed controllers. For example, the job engine may generate the controllers, with each controller configured to monitor a respective computing resource. For example, different types of controllers may be configured for different computing resource types. The job engine may create a list of tasks to be performed by each controller. A task list for a given controller may include tasks for monitoring computing resource performance, tasks for monitoring a state of resources, or both. The job engine may periodically generate new controllers for the computing resources, and the previous instances of the controllers may be deleted or removed from the system. By generating new controller instances periodically, the job engine may ensure that the task lists continue to execute through completion, even if a task in the list is not completed successfully or if a controller fails or is corrupted.

The controllers may additionally, or alternatively, mutate one or more computing resources. For example, the controllers may modify or adjust properties of a computing resource. The resource mutations may be performed independently from or in accordance with the monitoring of the computing resources. The job engine may thereby use the distributed controllers to ensure that the computing resources are continuously monitored and operating in a proper operating state, even if a local controller fails or is removed.

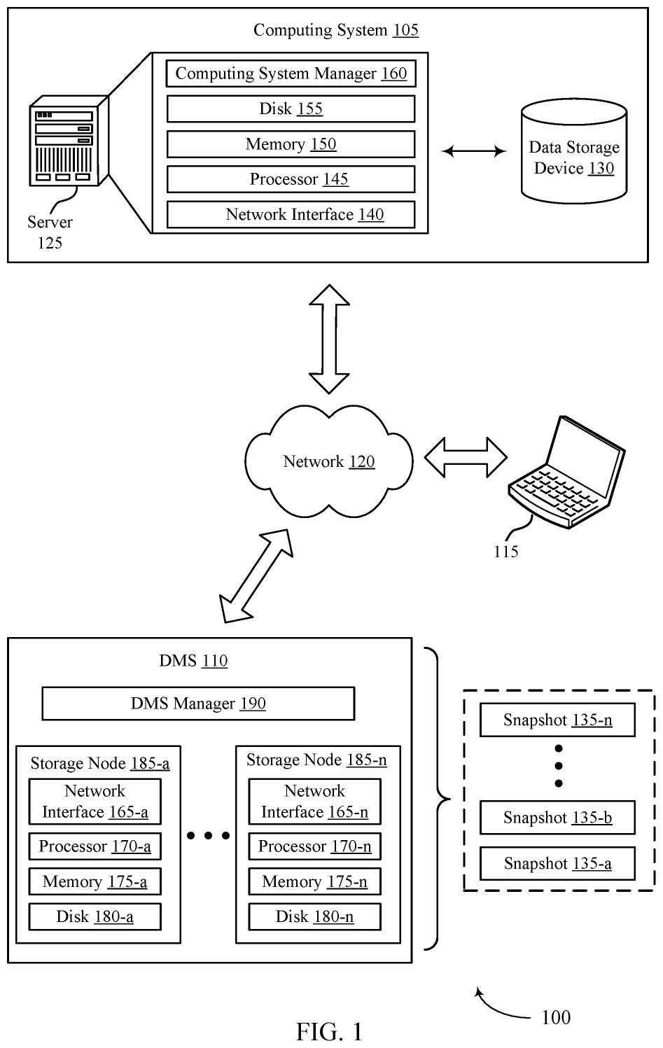

FIG. 1 illustrates an example of a computing environment 100 that supports distributed resource controllers for cloud infrastructure in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through SaaS or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 (e.g., network interfaces 165-a through 165-n) may enable the storage nodes 185 to connect to one another, to the network 120, or both. A network interface 165 may include one or more wireless network interfaces, one or more wired network interfaces, or any combination thereof. The processor 170 of a storage node 185 (e.g., the processors 170-a through 170-n of the storage nodes 185-a through 185-n) may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 (e.g., the disks 180-a through 180-n) may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 (e.g., snapshots 135-a, 135-b, through 135-n) associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the computing environment 100 may include a SaaS system (e.g., a DMS 110) that may operate using computing resources distributed across one or more cloud environments (e.g., computing resources in the computing system 105 and one or more other systems or clouds). The SaaS system may manage the resources, which may include a relatively large quantity of distributed cloud resources across different cloud platforms. It may be beneficial for the SaaS system to reliably monitor the resources and update or modify (e.g., mutate) that resources to ensure the computing resources are operating in a proper state. The SaaS system may include multiple controllers that monitor the computing resources and update or mutate (e.g., modify or otherwise alter) the computing resources as needed.

In some cases, the controllers may be local controllers that continuously monitor resources using logic local to the controllers. In such systems, if the monitoring indicates an issue with one or more computing resources, the controllers may perform updates to the computing resources or the updates may be performed manually by an engineer or operator. The local controllers may be generated when a SaaS service (e.g., a service or product provided by the SaaS system) is initiated. For example, the controller pattern may be a non-terminating loop that regulates the state of a system. The controller may operate in a single process and with relatively few resources. If such a local controller fails or is disrupted, there may not be a mechanism for restarting the controller, which may increase latency, increase processing resources, and reduce reliability.

As described herein, the computing environment 100 may include a SaaS system that supports a distributed controller framework. Such a framework may include distributed controllers for monitoring the computing resources used to instantiate one or more SaaS services across cloud environments. A job engine (e.g., a Korg engine or some other engine within the DMS 110) may be introduced that manages the distributed controllers. The job engine may generate the controllers, with each controller configured to monitor a respective computing resource. For example, different types of controllers may be configured for different computing resource types. The job engine may periodically generate new controllers for the computing resources, and the previous instances of the controllers may be deleted or removed from the system. By generating new controller instances periodically, the job engine may ensure that the task lists continue to execute through completion, even if a task in the list is not completed successfully or if a controller fails or is corrupted. The controllers may thereby monitor and update computing resources of the SaaS system in accordance with a distributed controller pattern, which may improve reliability and reduce processing resources.

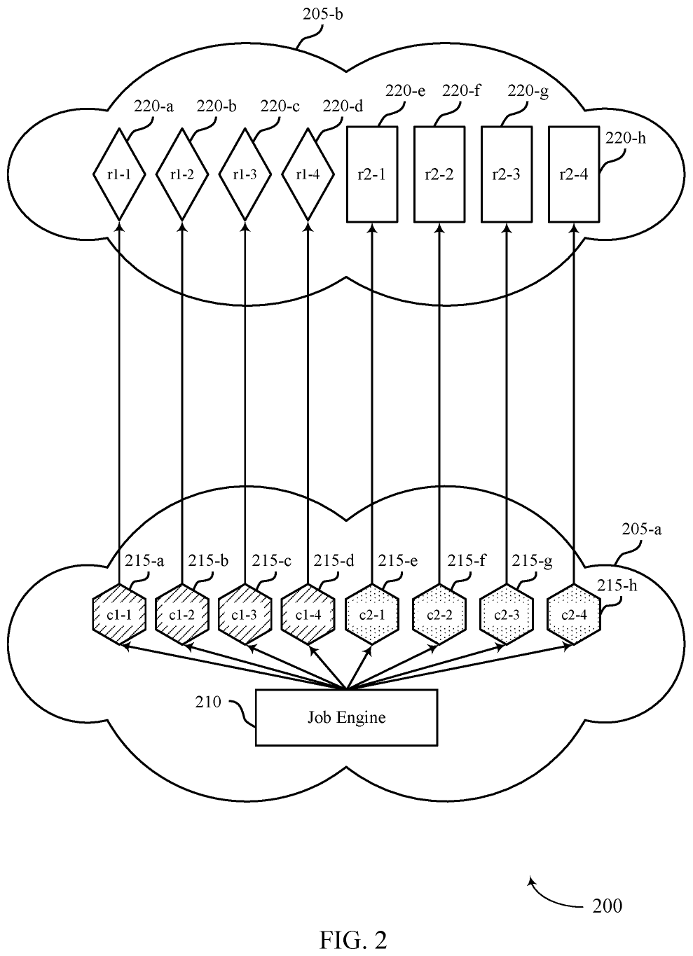

FIG. 2 shows an example of a SaaS system 200 that supports distributed resource controllers for cloud infrastructure in accordance with aspects of the present disclosure. The SaaS system 200 may implement or be implemented by aspects of the computing environment 100 described with reference to FIG. 1. For example, the SaaS system 200 may represent an example of a DMS 110 or some other system that is associated with one or more SaaS services. The SaaS system 200 includes multiple cloud environments 205 and computing resources 220, which may represent examples of corresponding environments and resources described with reference to FIG. 1. In this example, the SaaS system 200 may operate across two cloud environments 205-a and 205-b. However, it is to be understood that the SaaS system 200 may operate across any quantity of one or more cloud environments 205.

The services provided by the SaaS system 200 may be instantiated across the cloud environments 205-a and 205-b, as well as one or more other cloud environments (not pictured in FIG. 2) using the computing resources 220. The computing resources 220-a, 220-b, 220-c, and 220-d may be of a first type, as represented by the diamond shape in FIG. 2, and the computing resources 220-e, 220-f, 220-g, and 220-h may be of a second type, as represented by the rectangular shape in FIG. 2. Although two types of computing resources are illustrated in FIG. 2, it is to be understood that the SaaS system 200 may support any quantity of computing resource types, and each cloud environment 205 may include any quantity of one or more computing resource types.

The computing resource types may include, for example, cloud resources (e.g., Azure Kubernetes Services (AKS) clusters, Azure Storage Accounts, or some other type of cloud resources), resources associated with an infrastructure of the SaaS system (e.g., one or more subscriptions, such as an Azure subscription), resources associated with a portfolio of computing services provided by the SaaS system 200 (e.g., an ExoCluster, including AKS clusters, a storage account, a key vault, a network security group, or any combination thereof), resources associated with an expired portfolio of computing services (e.g., stale resources that may be candidates for garbage collection), one or more tenant network resources (e.g., a service principle, a certificate, a status of the tenant network, or the like), or any combination thereof. In some examples, one or more of the services or resources may further include a set of one or more sub-resources. For example, a resource cluster may be a composite portfolio resource that may include, for example, an API server, one or more deployment resources, one or more ports, or other types of resources.

As described with reference to FIG. 1, in some systems, the computing resources 220 may be monitored by local controllers, which may be in a same cloud environment 205 as the computing resources 220 and may operate on a continuous local logic loop. However, if such local controllers fail or are disrupted, the local loop may not be restarted, which may reduce reliability. Additionally, or alternatively, in such systems, if the local controllers detect an issue with a computing resource 220 or detect that a computing resource 220 has changed state based on the monitoring, the computing resource 220 may be updated manually by an operator of the system (e.g., using code generated to update the resource), which may increase costs and latency. In such cases, the design and code for running the system may be inconsistent and scattered, which may provide for relatively inconsistent services and reduced reliability. In some examples, one or more operations performed by a local controller to update or monitor a computing resource 220 may block or delay operations performed by the same or different local controllers to update or monitor the other computing resources 220 (e.g., due to, for example, sequential looping).

Techniques, systems, and devices described herein provide for a distributed controller framework. The SaaS system 200 may support the described distributed controller framework, in which the computing resources 220 may be monitored and adjusted by one or more distributed resource controllers 215. The distributed resource controllers 215 may be operable to ensure that the computing resources 220 operate in an eventually consistent and desired state, such that the SaaS system may satisfy a threshold level of data protection and backup reliability while maintaining relatively low processing and operational efforts. For example, the distributed monitoring framework may consume relatively few resources from the overall SaaS system 200.

The distributed resource controllers 215 and corresponding SaaS system 200 may operate in accordance with an infrastructure as code (IaC) model. For example, the monitoring and maintenance digital assets for the SaaS system 200 may be grouped into a centralized code repository for the system and fully distributed across one or more distributed controllers 215, which may improve quality control, knowledge sharing, and may reduce latency while maintain reliability and scalability of the system. The IaC model may provide for the infrastructure of the SaaS system 200 to be defined as a series of deltas defined in code that may be applied in a set order to migrate physical infrastructure to a latest (most recent) configuration. By deploying such an IaC model in a distributed manner across multiple resource controllers 215, the described system may be relatively scalable and reliable.

The SaaS system 200 may execute a separate job or set of tasks (e.g., a task chain) for each target resource that is to be monitored and/or reconciled. As described herein, the SaaS system may execute a separate job to turn the distributed set of tasks for each target resource into a respective controller 215 (e.g., represented by (IaC+Controller)×distributed tasks), which may support improved regulation and monitoring of cloud resources. For example, an operator or engineer of the SaaS system 200 may generate a relatively small amount of code to execute the system (e.g., the system may run based on a distributed set of business logic). The engineer or operator may code one or more core monitoring or mutating tasks, which may provide for relatively fast delivery of operational solutions for computing resources 220 and improved operational efficiency. For example, the described techniques may provide for an update of a firewall for multiple resource clusters and storage accounts automatically in a relatively short time period, as compared with a relatively long time period and operational effort to complete the same job by another system that utilizes local controllers.

The described maintenance jobs may execute periodically to enumerate the computing resources 220 in the cloud environments 205 and execute a list of tasks for each of the resources concurrently on top of a group of machines. That is, the job engine 210 may periodically generate multiple resource controllers 215 each associated with a respective target computing resource 220. The resource controllers 215 may be of one or more different types. The job engine 210 may generate a type of resource controller 215 based on a type of computing resource 220 that the resource controller 215 is configured to monitor. For example, the resource controllers 215-a, 215-b, 215-c, and 215-d may be of a first type, as shown by the diagonal shading illustrated in FIG. 2. The first type of resource controller 215 may be associated with or configured based on one or more parameters associated with the first type of computing resource 220 (e.g., the computing resources 220-a through 220-d). The resource controllers 215-e, 215-f, 215-g, and 215-h may be of a second type, as shown by the dotted shading illustrated in FIG. 2. The second type of resource controller 215 may be associated with or configured based on one or more parameters associated with the second type of computing resource 220 (e.g., the computing resources 220-e through 220-f).

The job engine 210 may generate a resource controller 215 to monitor each target computing resource 220. In some other examples, a single resource controller 215 may monitor a set of two or more computing resources 220 of a same resource type. The mapping between a single resource controller 215 and either a single computing resource 220 or a relatively small set of computing resources 220 may provide for improved memory and CPU usage. For example, the system may support a relatively large quantity of computing resources 220 while maintaining memory and CPU usage thresholds, which may maintain reliability and efficiency.

The job engine 210 may generate a set of tasks (e.g., a task chain) for each resource controller 215 upon generation of the resource controller 215. Each task in the set of tasks may be coded for a respective monitoring or reconciliation purpose and each task may execute independently. That is, one task failure may not impact other tasks in the set of tasks. For example, if the resource controller 215-a is executing a first task in a set of tasks for the resource controller 215-a, and the first task fails, the resource controller 215-a may continue to execute subsequent tasks in the set of tasks sequentially, irrespective of the failure of the first task. Such independence between tasks may provide more relatively consistent and reliable operation, which may improve reliability and reduce latency to ensure that the computing resources 220 are maintained in a correct state.

The resource controllers 215, once generated, may each be operable to execute the set of tasks. For example, the resource controller 215-b may monitor one or more parameters associated with the computing resource 220-b as part of executing one or more monitoring tasks in the set of tasks. The resource controller 215-b may additionally, or alternatively, modify (e.g., mutate or otherwise alter) one or more parameters associated with the computing resource 220-b as part of executing one or more mutation tasks in the set of tasks. The mutation tasks may, in some examples, be based on the monitoring tasks. For example, the mutation task may instruct the resource controller 215-b to modify one or more parameters of the computing resource 220-b based on a previously executed monitoring task indicating an issue with the one or more parameters. Additionally, or alternatively, the mutation task may be independent from the monitoring. For example, a mutation task may instruct the resource controller 215-b to modify one or more parameters of the computing resource 220-b based on instructions received from a client or an operator and irrespective of any monitoring of the computing resource 220-b.

In some examples, the tasks in the task chain for a given distributed resource controller 215 may be configured (e.g., coded) to address one or more issues that are addressable under an “eventual consistency” design principle. That is, the resource controllers 215 may execute tasks to monitor and modify the computing resources 220 such that if no new updates are made to any of the computing resources 220, any read of any computing resource 220 may eventually return a last or most recent updated value. The SaaS system 200 may ensure the eventual consistency by executing IaC for computing resource monitoring and mutation continuously using the distributed controllers 215, instead of in an on-demand basis.

The monitoring and mutating tasks may include one or more different types of tasks. An example monitoring task may be a SaaS capacity monitoring task, which may instruct a resource controller 215 to monitor for and report a CPU quota and memory usage associated with a computing resource 220 and one or more sub-resources within the computing resource 220 (e.g., each subscription within a resource cluster). Such a task may monitor CPU quota, memory usage, storage account limits or counts, or the like. The SaaS system 200 may determine (e.g., automatically or based on operator input) to modify one or more parameters associated with the computing resource 220, such as adjust a CPU quota or memory usage of the computing resource 220, based on the report generated by the monitoring task. In some examples, if the CPU quota exceeds a configured threshold, the SaaS system 200 may automatically generate a mutation task to modify the CPU quota.

Other example monitoring tasks may include monitoring one or more tenant-level assets. For example, a monitoring task may instruct a resource controller to monitor a status and/or expiration date of one or more service packs provided by the SaaS system 200 (e.g., a SaaS root service pack, a SaaS hosting subscription management service pack), monitor a status of one or more licenses associated with the SaaS system 200, monitor one or more registries or images associated with the SaaS system (e.g., a global Azure container registry (ACR) instance, a global ACR image pull Azure SP, or other containerized resources), monitor a status of a firewall associated with one or more resources, a status of one or more tenant certificates, or any combination thereof.

An example mutation task may be a storage account reconciliation task, which may instruct the resource controller 215 to calculate a limit or count associated with a storage account or other computing resource 220 based on latest CPU quota and storage counts obtained via monitoring the resources. Such a task may adjust the CPU quota based on the computation, which may improve reliability as compared with adjusting storage counts based on a static calculation.

Another example mutation task may include a deployment tag reconciliation task, which may instruct a resource controller 215 to tag each computing resource 220 (e.g., a subscription) with a corresponding deployment name and to ensure the proper deployment tag is present. In some other examples, a mutation task may instruct the resource controller 215 to trigger an alert or delete a computing resource 220 if a resource leak is detected (e.g., an expired resource). Some other mutation tasks may be associated with reconciling a firewall (e.g., an internet protocol (IP) list associated with the firewall), updating a basic load balancer to a standard load balancer for a given computing resource 220, performing garbage collection, or any combination thereof.

The monitoring and mutation tasks may thereby include a variety of tasks that, when executed by the resource controllers 215, are operable to continuously (e.g., periodically or at a relatively high frequency without intervention) monitor parameters associated with one or more resources and modify or otherwise alter the parameters based on the monitoring or based on other information included in the task. The parameters associated with the computing resource 220 may include a state and/or status of the computing resource (e.g., whether the computing resource 220 is valid, expired, active, disabled, or some other state), an expiration timing associated with the computing resource 220, a memory usage associated with the computing resource 220, one or more other parameters, or any combination thereof.

The cadence or periodicity at which the distributed controllers 215 execute the monitoring and mutating tasks may be adjustable by the SaaS system 200. For example, upon deployment or during operation of the SaaS system 200, an engineer or operator may code an adjustable execution cadence. The cadence may be selected based on one or more system parameters, such that the execution cadence may reduce processing complexity and improve system throughput.

As described herein, the job engine 210 may dynamically generate new instances of the resource controllers 215 according to a generation schedule. A new instance of a resource controller 215 may be generated as a replica (e.g., copy) of a previous instance of the resource controller 215 and may replace the previous instance. For example, the job engine 210 may generate a first instance of the resource controller 215-h at a first time. The first instance of the resource controller 215-h may execute a respective set of tasks for a time period. At a second time that is after or during the time period, the job engine 210 may generate a second instance of the resource controller 215-h. The second instance of the resource controller 215-h may replace the first instance and may start executing a respective set of tasks upon generation. In some examples, the second instance may continue executing the set of tasks generated for the first instance, or the job engine 210 may generate a second set of tasks for execution by the second instance. The first instance may be removed or deleted from the cloud environment 205-a to save storage capacity and reduce overhead.

The generation schedule may be a periodic or aperiodic schedule associated with timing for generation, by the job engine 210, of new instances of the resource controllers 215. That is, the job engine 210 may automatically generate new instances of each of the resources controllers 215 at a given time based on the generation schedule. A periodicity or time period associated with the generation schedule may be based on a life span of the resource controllers 215, in some examples. Additionally, or alternatively, the generation schedule may be based on one or more other operating parameters associated with the SaaS system.

The job engine 210 may generate the new instances of the resource controllers 215 to replace previous instances of the resource controllers 215, which may provide for improved reliability of the SaaS system 200. For example, if a resource controller 215, such as the resource controller 215-a, for example, fails, is disabled, or is deleted, the monitoring of the corresponding computing resource 220-a may be paused for a relatively short time period until the next time instance in the generation schedule, at which time, the job engine 210 may generate a new instance of the resource controller 215-a to replace the failed instance. In some examples, the job engine 210 may generate a new instance of a resource controller at a time that may not be identified in the generation schedule based on the job engine 210 identifying a failure or other issue of one of the resource controllers 215.

Although the computing resources 220 are illustrated as residing in the cloud environment 205-a in FIG. 2, it is to be understood that the computing resources 220 may reside in any one or more cloud environments 205. For example, the computing resources 220 may be in the same cloud environment 205-b as the resource controllers 215 and the job engine 210, or some of the computing resources 220 may be in one of the cloud environments 205-a and 205-b, and other computing resources 220 may be in a different cloud environment 205, or any combination thereof. Additionally, or alternatively, the job engine 210 and resource controllers 215 may be in any quantity of one or more cloud environments 205. For example, the job engine 210 may be in a different cloud environment than the resource controllers 215, in some examples.

The SaaS system 200 may thereby support a distributed framework for monitoring and modifying computing resources 220 to ensure the computing resources 220 are functioning properly and operating in a desired state. The described distributed controller framework may provide for improved reliability and efficiency as compared with other systems in which the resource controllers 215 may execute locally.

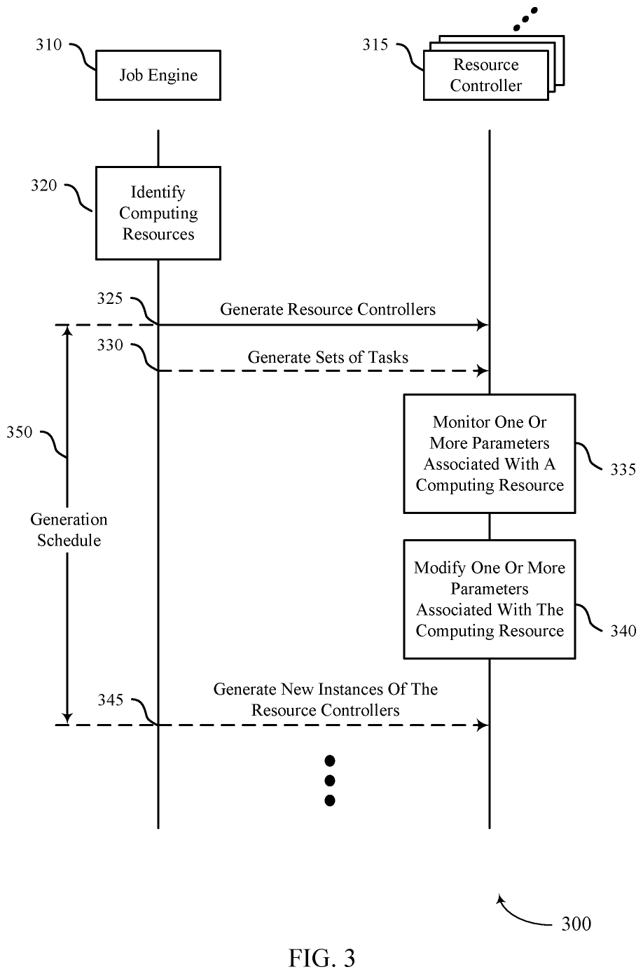

FIG. 3 shows an example of a process flow 300 that supports distributed resource controllers for cloud infrastructure in accordance with aspects of the present disclosure. The process flow 300 may implement or be implemented by aspects of FIGS. 1 and 2. For example, the process flow 300 may be implemented by a SaaS system 305 (e.g., a DMS), which may represent an example of a corresponding system as described with reference to FIGS. 1 and 2. The SaaS system 305 may include a job engine 310 and one or more resource controllers 315, which may represent examples of corresponding devices and components as described with reference to FIGS. 1 and 2. In this example, the SaaS system 305 may support a distributed framework for monitoring and mutating computing resources within the SaaS system 305.

In some aspects, the operations illustrated in the process flow 300 may be performed by hardware (e.g., including circuitry, processing blocks, logic components, and other components), code (e.g., software or firmware) executed by a processor, or any combination thereof. For example, aspects of the process flow 300 may be implemented or managed by a DMS, a job engine, or some other software or application that is associated with one or more SaaS services.

At 320, the job engine 310 may identify multiple computing resources distributed across one or more cloud environments. The computing resources may be of two or more different resource types. For example, the computing resources may include at least a first type of computing resource and a second type of computing resource and may be located in a same cloud environment as the job engine, one or more cloud environments different than the job engine, or any combination thereof, as described in further detail elsewhere herein, including with reference to FIG. 2. In some examples, the computing resources may include resources for operating the SaaS system 305, resources associated with one or more tenants of the SaaS system 305, or both.

At 325, the job engine 310 may generate multiple resource controllers 315 associated with the multiple computing resource. The multiple resource controllers 315 may be of two or more different controller types. Each resource controller 315 may be generated to monitor and/or modify (e.g., mapped to) a respective target resource. As such, the controller type may be based on a type of the corresponding target resource.

At 330, in some examples, the job engine 310 may generate multiple sets of tasks (e.g., task chains) for the resource controllers 315. Each set of tasks may include one or more tasks to be executed by a respective resource controller 315. The tasks may include monitoring and mutating tasks, as described in further detail elsewhere herein, including with reference to FIG. 2.

At 335, a resource controller 315 of the multiple generated resource controllers 315 may be operable to monitor one or more parameters associated with a corresponding computing resource. The resource controller 315 may perform the monitoring based on a task from among a set of tasks for the resource controller 315. For example, the set of tasks may include a monitoring task that may instruct the resource controller 315 to monitor one or more parameters associated with the computing resource.

At 340, the resource controller 315 may be operable to modify one or more parameters associated with the computing resource. The resource controller 315 may perform the modifying based on a task from among the set of tasks for the resource controller 315. For example, the set of tasks may include a mutation task that may instruct the resource controller 315 to modify the one or more parameters. In some examples, the modifying may be based on the monitoring. For example, the resource controller 315 may modify the one or more parameters based on information obtained while monitoring the one or more parameters. Additionally, or alternatively, the modifying may be independent from the modifying. For example, the resource controller 315 may modify the one or more parameters based on the task and irrespective of the monitoring task. In some examples, the parameters that are modified may be different than the parameters that are monitored.

Although FIG. 3 illustrates the resource controller 315 performing a monitoring task followed by a mutating task, it is to be understood that the resource controller 315 may perform any types of one or more tasks in any order. For example, the resource controller 315 may perform one or more monitoring tasks and may not perform a mutating task, or vice versa. Additionally, or alternatively, the resource controller 315 may perform a mutating task for the computing resource before performing the monitoring tasks. The type of tasks and order of execution of the tasks may be based on the set of tasks (e.g., task chain) that is generated by the job engine 310.

The other resource controllers 315 may similarly perform one or more monitoring and/or mutating tasks for other respective computing resources in parallel with the tasks being performed by the resource controller. In some examples, tasks within a single set of tasks may be independent from each other. For example, if the resource controller 315 fails to complete the monitoring tasks, the resource controller 315 may still perform the mutating task irrespective of a result of the monitoring task. The resource controller may thereby sequentially perform each task in the set of tasks regardless of an outcome of the independent tasks.

At 345, in some examples, the job engine 310 may generate new instances of each of the resource controllers 315. The previous instances of the resource controllers 315 may be replaced by the new instances. The previous instances may be deleted or removed from the system. The new instances may be replicas of the previous instances of the resource controllers 315. The job engine 310 may generate the new instances dynamically in accordance with a generation schedule 350. The generation schedule 350 may represent an example of a periodicity or other time period that indicates when the job engine 310 is to generate new instances of the resource controllers 315. The generation schedule 350 may be repetitive, such that the job engine 310 may continue to generate instances of the resource controllers 315, generate sets of tasks for execution by the instances of the resource controllers 315, and then remove the instances at the next generation time based on generation of new instances of the resource controllers 315, and so on. Such dynamic re-generation may provide for improved reliability of the distributed resource monitoring framework.

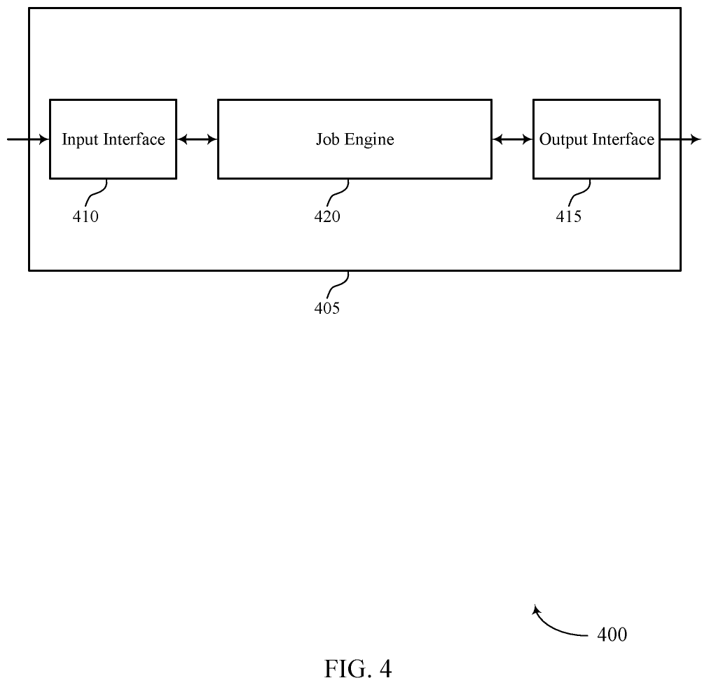

FIG. 4 shows a block diagram 400 of a system 405 that supports distributed resource controllers for cloud infrastructure in accordance with aspects of the present disclosure. The system 405 may be an example of aspects of a DMS as described herein. The system 405 may include an input interface 410, an output interface 415, and a job engine 420. The system 405 may also include a processor. Each of these components may be in communication with one another (e.g., via one or more buses).

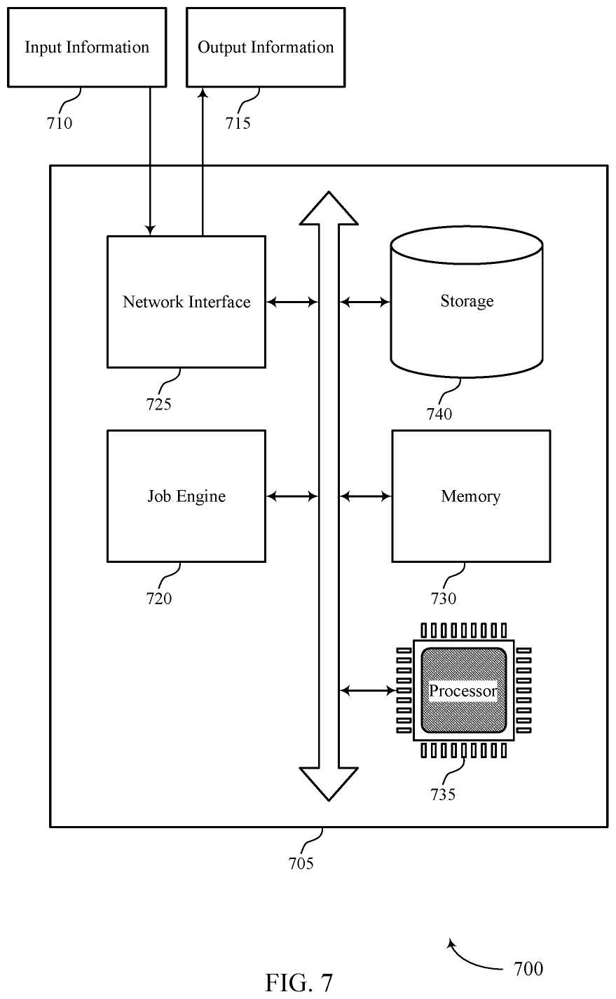

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the job engine 420 to support distributed resource controllers for cloud infrastructure. In some cases, the input interface 410 may be a component of a network interface 725 as described with reference to FIG. 7.

The output interface 415 may manage output signaling for the system 405. For example, the output interface 415 may receive signaling from other components of the system 405, such as the job engine 420, and may transmit such output signaling corresponding to (e.g., representative of or otherwise based on) such signaling to other systems or devices. In some cases, the output interface 415 may be a component of a network interface 725 as described with reference to FIG. 7.

The job engine 420, the input interface 410, the output interface 415, or various combinations thereof or various components thereof may be examples of means for performing various aspects of distributed resource controllers for cloud infrastructure as described herein. For example, the job engine 420, the input interface 410, the output interface 415, or various combinations or components thereof may support a method for performing one or more of the functions described herein.

In some examples, the job engine 420, the input interface 410, the output interface 415, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the job engine 420, the input interface 410, the output interface 415, or various combinations or components thereof may be implemented in code (e.g., as communications management software or firmware) executed by a processor. If implemented in code executed by a processor, the functions of the job engine 420, the input interface 410, the output interface 415, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the job engine 420 may be configured to perform various operations (e.g., receiving, monitoring, transmitting) using or otherwise in cooperation with the input interface 410, the output interface 415, or both. For example, the job engine 420 may receive information from the input interface 410, send information to the output interface 415, or be integrated in combination with the input interface 410, the output interface 415, or both to receive information, transmit information, or perform various other operations as described herein.

For example, the job engine 420 may be configured as or otherwise support a means for identifying, by a job engine associated with one or more software-as-a-service (SaaS) services, a set of multiple computing resources distributed across one or more cloud environments, where the set of multiple computing resources include computing resources of two or more different resource types. The job engine 420 may be configured as or otherwise support a means for generating, by the job engine, a set of multiple resource controllers associated with the set of multiple computing resources, where the set of multiple resource controllers include resource controllers of two or more different controller types, and where a resource controller of the set of multiple resource controllers is mapped to a computing resource of the set of multiple computing resources based on a resource type of the computing resource and a controller type of the resource controller, the resource controller operable to. The job engine 420 may be configured as or otherwise support a means for monitoring, based on a set of tasks generated by the job engine, one or more parameters associated with the computing resource. The job engine 420 may be configured as or otherwise support a means for modifying, based on the set of tasks generated by the job engine, the one or more parameters associated with the computing resource.

By including or configuring the job engine 420 in accordance with examples as described herein, the system 405 (e.g., a processor controlling or otherwise coupled with the input interface 410, the output interface 415, the job engine 420, or a combination thereof) may support techniques for reduced processing, reduced power consumption, more efficient utilization of computing resources, and improved reliability, among other examples.

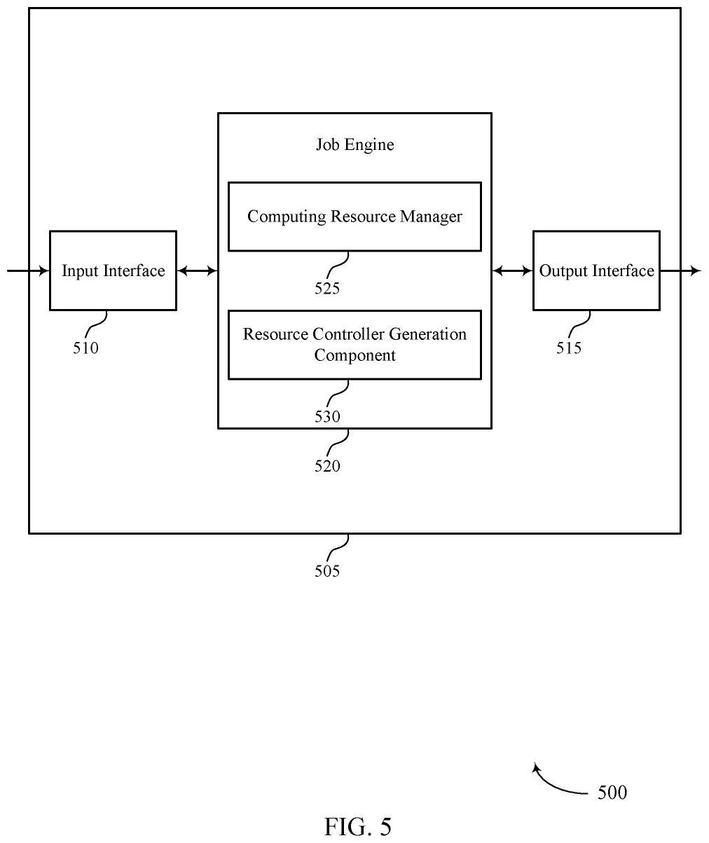

FIG. 5 shows a block diagram 500 of a system 505 that supports distributed resource controllers for cloud infrastructure in accordance with aspects of the present disclosure. In some examples, the system 505 may be an example of aspects of one or more components described with reference to FIG. 1, such as a DMS 110. The system 505 may include an input interface 510, an output interface 515, and a job engine 520. The system 505 may also include one or more processors. Each of these components may be in communication with one another (e.g., via one or more buses, communications links, communications interfaces, or any combination thereof).

The input interface 510 may manage input signaling for the system 505. For example, the input interface 510 may receive input signaling (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the job engine 520 to support distributed resource controllers for cloud infrastructure. In some cases, the input interface 510 may be a component of a network interface 725 as described with reference to FIG. 7.

The output interface 515 may manage output signaling for the system 505. For example, the output interface 515 may receive signaling from other components of the system 505, such as the job engine 520, and may transmit such output signaling corresponding to (e.g., representative of or otherwise based on) such signaling to other systems or devices. In some cases, the output interface 515 may be a component of a network interface 725 as described with reference to FIG. 7.

The system 505, or various components thereof, may be an example of means for performing various aspects of distributed resource controllers for cloud infrastructure as described herein. For example, the job engine 520 may include a computing resource manager 525 a resource controller generation component 530, or any combination thereof. The job engine 520 may be an example of aspects of a job engine 420 as described herein. In some examples, the job engine 520, or various components thereof, may be configured to perform various operations (e.g., receiving, monitoring, transmitting) using or otherwise in cooperation with the input interface 510, the output interface 515, or both. For example, the job engine 520 may receive information from the input interface 510, send information to the output interface 515, or be integrated in combination with the input interface 510, the output interface 515, or both to receive information, transmit information, or perform various other operations as described herein.

The computing resource manager 525 may be configured as or otherwise support a means for identifying, by a job engine associated with one or more software-as-a-service (SaaS) services, a set of multiple computing resources distributed across one or more cloud environments, where the set of multiple computing resources include computing resources of two or more different resource types. The resource controller generation component 530 may be configured as or otherwise support a means for generating, by the job engine, a set of multiple resource controllers associated with the set of multiple computing resources, where the set of multiple resource controllers include resource controllers of two or more different controller types, and where a resource controller of the set of multiple resource controllers is mapped to a computing resource of the set of multiple computing resources based on a resource type of the computing resource and a controller type of the resource controller. The resource controller may be configured as or otherwise support a means for monitoring, based on a set of tasks generated by the job engine, one or more parameters associated with the computing resource. The resource controller may be configured as or otherwise support a means for modifying, based on the set of tasks generated by the job engine, the one or more parameters associated with the computing resource.

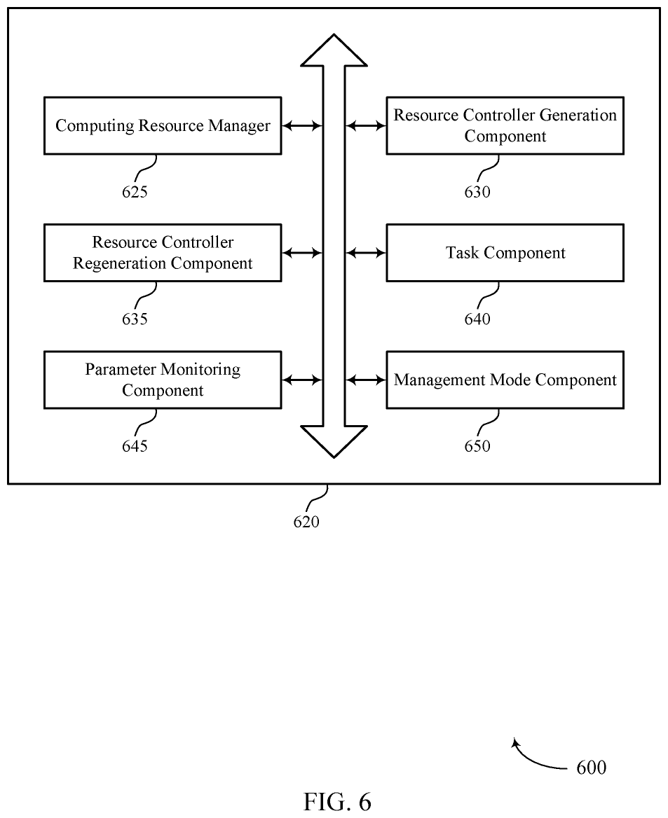

FIG. 6 shows a block diagram 600 of a job engine 620 that supports distributed resource controllers for cloud infrastructure in accordance with aspects of the present disclosure. The job engine 620 may be an example of aspects of a job engine 420, a job engine 520, or both, as described herein. The job engine 620, or various components thereof, may be an example of means for performing various aspects of distributed resource controllers for cloud infrastructure as described herein. For example, the job engine 620 may include a computing resource manager 625, a resource controller generation component 630, a resource controller regeneration component 635, a task component 640, a parameter monitoring component 645, a management mode component 650, or any combination thereof. Each of these components may communicate, directly or indirectly, with one another (e.g., via one or more buses, communications links, communications interfaces, or any combination thereof).

The computing resource manager 625 may be configured as or otherwise support a means for identifying, by a job engine associated with one or more software-as-a-service (SaaS) services, a set of multiple computing resources distributed across one or more cloud environments, where the set of multiple computing resources include computing resources of two or more different resource types. The resource controller generation component 630 may be configured as or otherwise support a means for generating, by the job engine, a set of multiple resource controllers associated with the set of multiple computing resources, where the set of multiple resource controllers include resource controllers of two or more different controller types, and where a resource controller of the set of multiple resource controllers is mapped to a computing resource of the set of multiple computing resources based on a resource type of the computing resource and a controller type of the resource controller. In some examples, the resource controller may be configured as or otherwise support a means for monitoring, based on a set of tasks generated by the job engine, one or more parameters associated with the computing resource. In some examples, the resource controller may be configured as or otherwise support a means for modifying, based on the set of tasks generated by the job engine, the one or more parameters associated with the computing resource.

In some examples, the resource controller regeneration component 635 may be configured as or otherwise support a means for generating, in accordance with a generation schedule, second instances of the set of multiple resource controllers, where first instances of the set of multiple resource controllers are replaced by the generated second instances.

In some examples, the generation schedule is based on a life span of the set of multiple resource controllers. In some examples, the generation schedule corresponds to a time period over which respective first instances of the set of multiple resource controllers operate before subsequent instances of the set of multiple resource controllers are generated to replace the respective first instances of the set of multiple resource controllers.

In some examples, the management mode component 650 may be configured as or otherwise support a means for operating according to a computing resource management mode, where generating the set of multiple resource controllers and the second instances of the set of multiple resource controllers is based on the computing resource management mode. In some examples, the management mode component 650 may be configured as or otherwise support a means for refraining from generating additional instances of the set of multiple resource controllers based on a deactivation of the computing resource management mode.

In some examples, the task component 640 may be configured as or otherwise support a means for generating, after generating the set of multiple resource controllers, a set of multiple sets of tasks for the set of multiple resource controllers, where the set of tasks is one of the set of multiple sets of tasks and includes tasks to be executed by the resource controller.

In some examples, the resource controller is further operable to execute the tasks of the set of tasks in sequential order. In some examples, execution of a sequential task in the set of tasks is independent from a success or a failure of a previous task in the set of tasks.

In some examples, to modify the one or more parameters associated with the computing resource, the resource controller is operable to adjust a state of the one or more parameters based on information obtained via monitoring the one or more parameters.

In some examples, to modify the one or more parameters associated with the computing resource, the resource controller is operable to adjust a state of the one or more parameters based on a mutation task included in the set of tasks for the resource controller and independent from information obtained via monitoring the one or more parameters.

In some examples, the job engine, the set of multiple resource controllers, and the set of multiple computing resources operate in a first cloud environment.

In some examples, the job engine and the set of multiple resource controllers operate in a first cloud environment. In some examples, the set of multiple computing resources operate in a second cloud environment different than the first cloud environment.

In some examples, to monitor the one or more parameters associated with the computing resource, the resource controller is operable to monitor a performance of one or more units of processing power associated with the computing resource, or to monitor the one or more parameters associated with the computing resource, the resource controller is operable to monitor a state of a cluster including the computing resource, or both.

In some examples, the set of multiple computing resources include individual computing resources, or computing resource clusters, or both.

FIG. 7 shows a block diagram 700 of a system 705 that supports distributed resource controllers for cloud infrastructure in accordance with aspects of the present disclosure. The system 705 may be an example of or include the components of a system 405, a system 505, or a DMS as described herein. The system 705 may include components for data management, including components such as a job engine 720, an input information 710, an output information 715, a network interface 725, a memory 730, a processor 735, and a storage 740. These components may be in electronic communication or otherwise coupled with each other (e.g., operatively, communicatively, functionally, electronically, electrically; via one or more buses, communications links, communications interfaces, or any combination thereof). Additionally, the components of the system 705 may include corresponding physical components or may be implemented as corresponding virtual components (e.g., components of one or more virtual machines). In some examples, the system 705 may be an example of aspects of one or more components described with reference to FIG. 1, such as a DMS 110.

The network interface 725 may enable the system 705 to exchange information (e.g., input information 710, output information 715, or both) with other systems or devices (not shown). For example, the network interface 725 may enable the system 705 to connect to a network (e.g., a network 120 as described herein). The network interface 725 may include one or more wireless network interfaces, one or more wired network interfaces, or any combination thereof. In some examples, the network interface 725 may be an example of may be an example of aspects of one or more components described with reference to FIG. 1, such as one or more network interfaces 165.

Memory 730 may include RAM, ROM, or both. The memory 730 may store computer-readable, computer-executable software including instructions that, when executed, cause the processor 735 to perform various functions described herein. In some cases, the memory 730 may contain, among other things, a basic input/output system (BIOS), which may control basic hardware or software operation such as the interaction with peripheral components or devices. In some cases, the memory 730 may be an example of aspects of one or more components described with reference to FIG. 1, such as one or more memories 175.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in a memory 730 to perform various functions (e.g., functions or tasks supporting distributed resource controllers for cloud infrastructure). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. In some cases, the processor 735 may be an example of aspects of one or more components described with reference to FIG. 1, such as one or more processors 170.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1, such as one or more network disks 180.

For example, the job engine 720 may be configured as or otherwise support a means for identifying, by a job engine associated with one or more software-as-a-service (SaaS) services, a set of multiple computing resources distributed across one or more cloud environments, where the set of multiple computing resources include computing resources of two or more different resource types. The job engine 720 may be configured as or otherwise support a means for generating, by the job engine, a set of multiple resource controllers associated with the set of multiple computing resources, where the set of multiple resource controllers include resource controllers of two or more different controller types, and where a resource controller of the set of multiple resource controllers is mapped to a computing resource of the set of multiple computing resources based on a resource type of the computing resource and a controller type of the resource controller. The resource controller may be configured as or otherwise support a means for monitoring, based on a set of tasks generated by the job engine, one or more parameters associated with the computing resource and modifying, based on the set of tasks generated by the job engine, the one or more parameters associated with the computing resource.

By including or configuring the job engine 720 in accordance with examples as described herein, the system 705 may support techniques for distributed resource controllers for cloud infrastructure, which may provide one or more benefits such as, for example, improved reliability, reduced latency, improved user experience, more efficient utilization of computing resources, network resources or both, improved scalability, and improved security, among other possibilities.

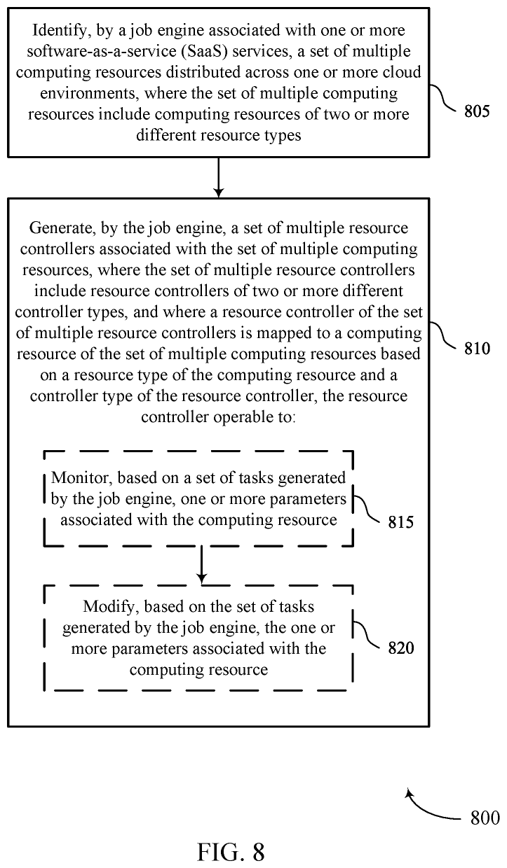

FIG. 8 shows a flowchart illustrating a method 800 that supports distributed resource controllers for cloud infrastructure in accordance with aspects of the present disclosure. The operations of the method 800 may be implemented by a DMS or its components as described herein. For example, the operations of the method 800 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 805, the method may include identifying, by a job engine associated with one or more SaaS services, a set of multiple computing resources distributed across one or more cloud environments, where the set of multiple computing resources include computing resources of two or more different resource types. The operations of block 805 may be performed in accordance with examples as disclosed herein. In some examples, aspects of the operations of 805 may be performed by a computing resource manager 625 as described with reference to FIG. 6.

At 810, the method may include generating, by the job engine, a set of multiple resource controllers associated with the set of multiple computing resources, where the set of multiple resource controllers include resource controllers of two or more different controller types, and where a resource controller of the set of multiple resource controllers is mapped to a computing resource of the set of multiple computing resources based on a resource type of the computing resource and a controller type of the resource controller. At 815, the resource controller may be operable to monitor, based on a set of tasks generated by the job engine, one or more parameters associated with the computing resource. At 820, the resource controller may be operable to modify, based on the set of tasks generated by the job engine, the one or more parameters associated with the computing resource. The operations of block 810 may be performed in accordance with examples as disclosed herein. In some examples, aspects of the operations of 810 may be performed by a resource controller generation component 630 as described with reference to FIG. 6.

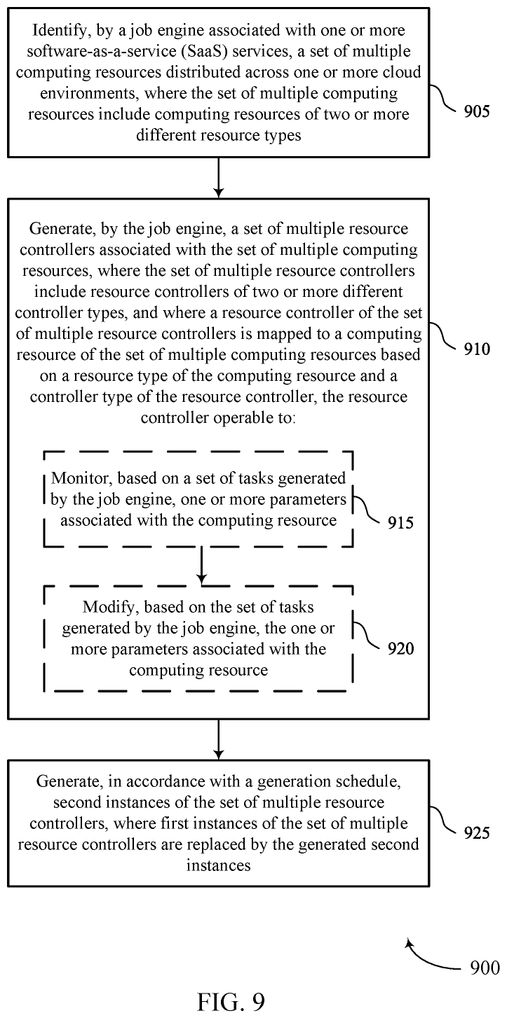

FIG. 9 shows a flowchart illustrating a method 900 that supports distributed resource controllers for cloud infrastructure in accordance with aspects of the present disclosure. The operations of the method 900 may be implemented by a DMS or its components as described herein. For example, the operations of the method 900 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 905, the method may include identifying, by a job engine associated with one or more SaaS services, a set of multiple computing resources distributed across one or more cloud environments, where the set of multiple computing resources include computing resources of two or more different resource types. The operations of block 905 may be performed in accordance with examples as disclosed herein. In some examples, aspects of the operations of 905 may be performed by a computing resource manager 625 as described with reference to FIG. 6.

At 910, the method may include generating, by the job engine, a set of multiple resource controllers associated with the set of multiple computing resources, where the set of multiple resource controllers include resource controllers of two or more different controller types, and where a resource controller of the set of multiple resource controllers is mapped to a computing resource of the set of multiple computing resources based on a resource type of the computing resource and a controller type of the resource controller. At 915, the resource controller may be operable to monitor, based on a set of tasks generated by the job engine, one or more parameters associated with the computing resource. At 920, the resource controller may be operable to modify, based on the set of tasks generated by the job engine, the one or more parameters associated with the computing resource. The operations of block 910 may be performed in accordance with examples as disclosed herein. In some examples, aspects of the operations of 910 may be performed by a resource controller generation component 630 as described with reference to FIG. 6.

At 925, the method may include generating, in accordance with a generation schedule, second instances of the set of multiple resource controllers, where first instances of the set of multiple resource controllers are replaced by the generated second instances. The operations of block 925 may be performed in accordance with examples as disclosed herein. In some examples, aspects of the operations of 925 may be performed by a resource controller regeneration component 635 as described with reference to FIG. 6.

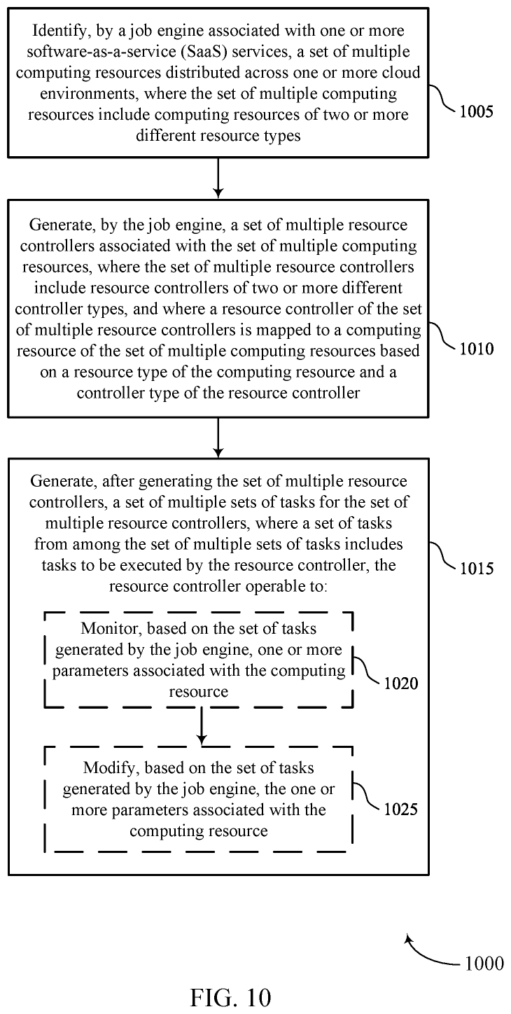

FIG. 10 shows a flowchart illustrating a method 1000 that supports distributed resource controllers for cloud infrastructure in accordance with aspects of the present disclosure. The operations of the method 1000 may be implemented by a DMS or its components as described herein. For example, the operations of the method 1000 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 1005, the method may include identifying, by a job engine associated with one or more SaaS services, a set of multiple computing resources distributed across one or more cloud environments, where the set of multiple computing resources include computing resources of two or more different resource types. The operations of block 1005 may be performed in accordance with examples as disclosed herein. In some examples, aspects of the operations of 1005 may be performed by a computing resource manager 625 as described with reference to FIG. 6.

At 1010, the method may include generating, by the job engine, a set of multiple resource controllers associated with the set of multiple computing resources, where the set of multiple resource controllers include resource controllers of two or more different controller types, and where a resource controller of the set of multiple resource controllers is mapped to a computing resource of the set of multiple computing resources based on a resource type of the computing resource and a controller type of the resource controller. The operations of block 1010 may be performed in accordance with examples as disclosed herein. In some examples, aspects of the operations of 1010 may be performed by a resource controller generation component 630 as described with reference to FIG. 6.

At 1015, the method may include generating, after generating the set of multiple resource controllers, a set of multiple sets of tasks for the set of multiple resource controllers, where the set of tasks is one of the set of multiple sets of tasks and includes tasks to be executed by the resource controller. At 1020, the resource controller may be operable to monitor, based on the set of tasks generated by the job engine, one or more parameters associated with the computing resource. At 1025, the resource controller may be operable to modify, based on the set of tasks generated by the job engine, the one or more parameters associated with the computing resource. The operations of block 1015 may be performed in accordance with examples as disclosed herein. In some examples, aspects of the operations of 1015 may be performed by a task component 640 as described with reference to FIG. 6.

A method is described. The method may include identifying, by a job engine associated with one or more SaaS services, a set of multiple computing resources distributed across one or more cloud environments, where the set of multiple computing resources include computing resources of two or more different resource types, generating, by the job engine, a set of multiple resource controllers associated with the set of multiple computing resources, where the set of multiple resource controllers include resource controllers of two or more different controller types, and where a resource controller of the set of multiple resource controllers is mapped to a computing resource of the set of multiple computing resources based on a resource type of the computing resource and a controller type of the resource controller, the resource controller operable to monitor, based on a set of tasks generated by the job engine, one or more parameters associated with the computing resource, and modify, based on the set of tasks generated by the job engine, the one or more parameters associated with the computing resource.

An apparatus is described. The apparatus may include a processor, memory coupled with the processor, and instructions stored in the memory. The instructions may be executable by the processor to cause the apparatus to identify, by a job engine associated with one or more SaaS services, a set of multiple computing resources distributed across one or more cloud environments, where the set of multiple computing resources include computing resources of two or more different resource types, generate, by the job engine, a set of multiple resource controllers associated with the set of multiple computing resources, where the set of multiple resource controllers include resource controllers of two or more different controller types, and where a resource controller of the set of multiple resource controllers is mapped to a computing resource of the set of multiple computing resources based on a resource type of the computing resource and a controller type of the resource controller, the resource controller operable to monitor, based on a set of tasks generated by the job engine, one or more parameters associated with the computing resource, and modify, based on the set of tasks generated by the job engine, the one or more parameters associated with the computing resource.

Another apparatus is described. The apparatus may include means for identifying, by a job engine associated with one or more SaaS services, a set of multiple computing resources distributed across one or more cloud environments, where the set of multiple computing resources include computing resources of two or more different resource types, means for generating, by the job engine, a set of multiple resource controllers associated with the set of multiple computing resources, where the set of multiple resource controllers include resource controllers of two or more different controller types, and where a resource controller of the set of multiple resource controllers is mapped to a computing resource of the set of multiple computing resources based on a resource type of the computing resource and a controller type of the resource controller, the resource controller operable to monitor, based on a set of tasks generated by the job engine, one or more parameters associated with the computing resource, and modify, based on the set of tasks generated by the job engine, the one or more parameters associated with the computing resource.

A non-transitory computer-readable medium storing code is described. The code may include instructions executable by a processor to identify, by a job engine associated with one or more SaaS services, a set of multiple computing resources distributed across one or more cloud environments, where the set of multiple computing resources include computing resources of two or more different resource types, generate, by the job engine, a set of multiple resource controllers associated with the set of multiple computing resources, where the set of multiple resource controllers include resource controllers of two or more different controller types, and where a resource controller of the set of multiple resource controllers is mapped to a computing resource of the set of multiple computing resources based on a resource type of the computing resource and a controller type of the resource controller, the resource controller operable to monitor, based on a set of tasks generated by the job engine, one or more parameters associated with the computing resource, and modify, based on the set of tasks generated by the job engine, the one or more parameters associated with the computing resource.

Some examples of the method, apparatuses, and non-transitory computer-readable medium described herein may further include operations, features, means, or instructions for generating, in accordance with a generation schedule, second instances of the set of multiple resource controllers, where first instances of the set of multiple resource controllers may be replaced by the generated second instances.

In some examples of the method, apparatuses, and non-transitory computer-readable medium described herein, the generation schedule may be based on a life span of the set of multiple resource controllers and the generation schedule corresponds to a time period over which respective first instances of the set of multiple resource controllers operate before subsequent instances of the set of multiple resource controllers may be generated to replace the respective first instances of the set of multiple resource controllers.

Some examples of the method, apparatuses, and non-transitory computer-readable medium described herein may further include operations, features, means, or instructions for operating according to a computing resource management mode, where generating the set of multiple resource controllers and the second instances of the set of multiple resource controllers may be based on the computing resource management mode and refraining from generating additional instances of the set of multiple resource controllers based on a deactivation of the computing resource management mode.

Some examples of the method, apparatuses, and non-transitory computer-readable medium described herein may further include operations, features, means, or instructions for generating, after generating the set of multiple resource controllers, a set of multiple sets of tasks for the set of multiple resource controllers, where the set of tasks may be one of the set of multiple sets of tasks and includes tasks to be executed by the resource controller.

In some examples of the method, apparatuses, and non-transitory computer-readable medium described herein, the resource controller may be further operable to execute the tasks of the set of tasks in sequential order and execution of a sequential task in the set of tasks may be independent from a success or a failure of a previous task in the set of tasks.

In some examples of the method, apparatuses, and non-transitory computer-readable medium described herein, to modify the one or more parameters associated with the computing resource, the resource controller may be operable to adjust a state of the one or more parameters based on information obtained via monitoring the one or more parameters.

In some examples of the method, apparatuses, and non-transitory computer-readable medium described herein, to modify the one or more parameters associated with the computing resource, the resource controller may be operable to adjust a state of the one or more parameters based on a mutation task included in the set of tasks for the resource controller and independent from information obtained via monitoring the one or more parameters.

In some examples of the method, apparatuses, and non-transitory computer-readable medium described herein, the job engine, the set of multiple resource controllers, and the set of multiple computing resources operate in a first cloud environment.

In some examples of the method, apparatuses, and non-transitory computer-readable medium described herein, the job engine and the set of multiple resource controllers operate in a first cloud environment and the set of multiple computing resources operate in a second cloud environment different than the first cloud environment.

Some examples of the method, apparatuses, and non-transitory computer-readable medium described herein may further include operations, features, means, or instructions for monitor a performance of one or more units of processing power associated with the computing resource, monitor a state of a cluster including the computing resource, and both.

In some examples of the method, apparatuses, and non-transitory computer-readable medium described herein, the set of multiple computing resources include individual computing resources, or computing resource clusters, or both.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
identifying, by a job engine associated with one or more software-as-a-service (SaaS) services, a plurality of computing resources distributed across one or more cloud environments, wherein the plurality of computing resources comprise computing resources of two or more different resource types; and
generating, by the job engine, a plurality of resource controllers associated with the plurality of computing resources, wherein the plurality of resource controllers comprise resource controllers of two or more different controller types, and wherein a resource controller of the plurality of resource controllers is mapped to a computing resource of the plurality of computing resources based at least in part on a resource type of the computing resource and a controller type of the resource controller, the resource controller operable to:
monitor, based at least in part on a set of tasks generated by the job engine, one or more parameters associated with the computing resource; and
modify, based at least in part on the set of tasks generated by the job engine, the one or more parameters associated with the computing resource.

2. The method of claim 1, further comprising:
generating, in accordance with a generation schedule, second instances of the plurality of resource controllers, wherein first instances of the plurality of resource controllers are replaced by the generated second instances.

3. The method of claim 2, wherein:
the generation schedule is based at least in part on a life span of the plurality of resource controllers, and
the generation schedule corresponds to a time period over which respective first instances of the plurality of resource controllers operate before subsequent instances of the plurality of resource controllers are generated to replace the respective first instances of the plurality of resource controllers.

4. The method of claim 2, further comprising:
operating according to a computing resource management mode, where generating the plurality of resource controllers and the second instances of the plurality of resource controllers is based at least in part on the computing resource management mode; and
refraining from generating additional instances of the plurality of resource controllers based at least in part on a deactivation of the computing resource management mode.

5. The method of claim 1, further comprising:
generating, after generating the plurality of resource controllers, a plurality of sets of tasks for the plurality of resource controllers, wherein the set of tasks is one of the plurality of sets of tasks and comprises tasks to be executed by the resource controller.

6. The method of claim 5, wherein:
the resource controller is further operable to execute the tasks of the set of tasks in sequential order, and
execution of a sequential task in the set of tasks is independent from a success or a failure of a previous task in the set of tasks.

7. The method of claim 1, wherein, to modify the one or more parameters associated with the computing resource, the resource controller is operable to adjust a state of the one or more parameters based at least in part on information obtained via monitoring the one or more parameters.

8. The method of claim 1, wherein, to modify the one or more parameters associated with the computing resource, the resource controller is operable to adjust a state of the one or more parameters based at least in part on a mutation task included in the set of tasks for the resource controller and independent from information obtained via monitoring the one or more parameters.

9. The method of claim 1, wherein the job engine, the plurality of resource controllers, and the plurality of computing resources operate in a first cloud environment.

10. The method of claim 1, wherein:
the job engine and the plurality of resource controllers operate in a first cloud environment; and
the plurality of computing resources operate in a second cloud environment different than the first cloud environment.

11. The method of claim 1, wherein, to monitor the one or more parameters associated with the computing resource, the resource controller is operable to:
monitor a performance of one or more units of processing power associated with the computing resource, or a state of a cluster comprising the computing resource, or both.

12. The method of claim 1, wherein the plurality of computing resources comprise individual computing resources, or computing resource clusters, or both.

13. An apparatus, comprising:
a processor;
memory coupled with the processor; and
instructions stored in the memory and executable by the processor to cause the apparatus to:
identify, by a job engine associated with one or more software-as-a-service (SaaS) services, a plurality of computing resources distributed across one or more cloud environments, wherein the plurality of computing resources comprise computing resources of two or more different resource types; and
generate, by the job engine, a plurality of resource controllers associated with the plurality of computing resources, wherein the plurality of resource controllers comprise resource controllers of two or more different controller types, and wherein a resource controller of the plurality of resource controllers is mapped to a computing resource of the plurality of computing resources based at least in part on a resource type of the computing resource and a controller type of the resource controller, the resource controller operable to:
monitor, based at least in part on a set of tasks generated by the job engine, one or more parameters associated with the computing resource; and
modify, based at least in part on the set of tasks generated by the job engine, the one or more parameters associated with the computing resource.

14. The apparatus of claim 13, wherein the instructions are further executable by the processor to cause the apparatus to:
generate, in accordance with a generation schedule, second instances of the plurality of resource controllers, wherein first instances of the plurality of resource controllers are replaced by the generated second instances.

15. The apparatus of claim 14, wherein:
the generation schedule is based at least in part on a life span of the plurality of resource controllers, and
the generation schedule corresponds to a time period over which respective first instances of the plurality of resource controllers operate before subsequent instances of the plurality of resource controllers are generated to replace the respective first instances of the plurality of resource controllers.

16. The apparatus of claim 14, wherein the instructions are further executable by the processor to cause the apparatus to:
operate according to a computing resource management mode, where generating the plurality of resource controllers and the second instances of the plurality of resource controllers is based at least in part on the computing resource management mode; and
refrain from generating additional instances of the plurality of resource controllers based at least in part on a deactivation of the computing resource management mode.

17. The apparatus of claim 13, wherein the instructions are further executable by the processor to cause the apparatus to:
generate, after generating the plurality of resource controllers, a plurality of sets of tasks for the plurality of resource controllers, wherein the set of tasks is one of the plurality of sets of tasks and comprises tasks to be executed by the resource controller.

18. A non-transitory computer-readable medium storing code, the code comprising instructions executable by a processor to:
identify, by a job engine associated with one or more software-as-a-service (SaaS) services, a plurality of computing resources distributed across one or more cloud environments, wherein the plurality of computing resources comprise computing resources of two or more different resource types; and
generate, by the job engine, a plurality of resource controllers associated with the plurality of computing resources, wherein the plurality of resource controllers comprise resource controllers of two or more different controller types, and wherein a resource controller of the plurality of resource controllers is mapped to a computing resource of the plurality of computing resources based at least in part on a resource type of the computing resource and a controller type of the resource controller, the resource controller operable to:
monitor, based at least in part on a set of tasks generated by the job engine, one or more parameters associated with the computing resource; and
modify, based at least in part on the set of tasks generated by the job engine, the one or more parameters associated with the computing resource.

19. The non-transitory computer-readable medium of claim 18, wherein the instructions are further executable by the processor to:
generate, in accordance with a generation schedule, second instances of the plurality of resource controllers, wherein first instances of the plurality of resource controllers are replaced by the generated second instances.

20. The non-transitory computer-readable medium of claim 18, wherein the instructions are further executable by the processor to:
generate, after generating the plurality of resource controllers, a plurality of sets of tasks for the plurality of resource controllers, wherein the set of tasks is one of the plurality of sets of tasks and comprises tasks to be executed by the resource controller.
